(19) United States
(12) Patent Application Publication
(10) Pub. No.: US 2024/0253913 A1
(43) Pub. Date: Aug. 1, 2024

(54) TUBE LIFTER

(71) Applicant: J.Schmalz GmbH, Glatten (DE)

(72) Inventors: Hans Burt, Horb a.N. (DE); Fabian Urbschat, Baiersbronn (DE); Daniel Müller, Haiterbach (DE); Arthur Hoppe, Loßburg (DE); Stefan Dreher, Wildberg (DE)

(73) Assignee: J.Schmalz GmbH, Glatten (DE)

(21) Appl. No.: 18/429,621

(22) Filed: Feb. 1, 2024

(30) Foreign Application Priority Data
Feb. 1, 2023 (DE) 10 2023 102 439.6

(51) Int. Cl. B65G 47/91

(52) U.S. Cl. CPC B65G 47/91

(57) ABSTRACT

A tube lifter comprising a lifting tube extending along a lifting tube longitudinal axis, an end effector and a coupling device, by way of the end effector being coupled to the lifting tube, wherein the coupling device has a lifting tube-side first coupling portion and an end effector-side second coupling portion, wherein one of the coupling portions has an insertion portion and the other coupling portion has a receiving portion for receiving the insertion portion, wherein the insertion portion and the receiving portion are designed such that the insertion portion can be inserted into the receiving portion in an insertion direction, and the end effector and the lifting tube can thereby be connected to one another, wherein the insertion portion can be inserted into the receiving portion in different rotary positions about an end effector rotation axis orthogonal to the insertion direction.

The present invention relates to a tube lifter according to the preamble of claim 1.

Tube lifters are vacuum handling devices by means of which loads can be lifted, optionally moved and then set down again by means of a vacuum. The lifting force is exerted by means of a lifting tube which can be shortened by applying a vacuum to the tube interior thereof and can be extended again by releasing the vacuum prevailing therein, possibly under the action of gravity. An end effector for gripping an object is usually arranged at one end of the lifting tube. This can be a mechanical gripping device, for example, but in particular a suction gripping device.

A coupling device is provided for coupling the end effector to the lifting tube, by means of which coupling device the end effector is connectable to the lifting tube. Various solutions are known for this purpose. For example, it is known to screw the end effector to the lifting tube. Document DE 10 2008 028 205 C5 describes a coupling device in which the suction gripper has four uniformly arranged locking pins which engage in keyhole-like receiving openings on the underside of the coupling. A connection between end effector and lifting tube can then be established by bayonet-like rotation of the suction gripper.

The aforementioned solutions usually require the precise insertion of one connection portion into the other, which makes handling more difficult during coupling of a suction gripper, since, for example, the end effector can only be connected to the lifting tube in a quite specific rotational position. In addition, the known designs are designed to be comparatively complicated and high-structured.

The object of the invention is to improve the coupling of an end effector to a lifting tube, in particular to enable a simple and intuitive coupling of an end effector to the lifting tube. Furthermore, a simple and robust structural design is desirable.

This object is achieved according to the invention by a tube lifter having the features of claim 1.

The tube lifter comprises a lifting tube which extends along a preferably vertical lifting tube longitudinal axis. The lifting tube has, in particular, a tube interior. The lifting tube can in particular be shortened by applying a vacuum to the tube interior.

The tube lifter additionally comprises an end effector, in particular a gripping device, for gripping an object. Preferably, the tube lifter comprises a suction gripping device, for example a surface suction gripper, elastomer suction cup or a suction spider.

The tube lifter also comprises a coupling device for coupling the end effector to the lifting tube, in particular in a repeatably releasable manner. The end effector in this sense can thus be coupled, or is coupled to the lifting tube by means of the coupling device, in particular in a repeatably releasable manner. The coupling device comprises a lifting tube-side first coupling portion, which is connected to the lifting tube, and an end effector-side second coupling portion which is connected to the end effector.

One of the two coupling portions, i.e., either the first coupling portion or the second coupling portion, has an insertion portion and the other coupling portion, i.e., the second or the first coupling portion, has a receiving portion for receiving the insertion portion. The receiving portion and the insertion portion are designed, in particular coordinated with one another, in such a way that the insertion portion can be inserted, in particular pushed, into the receiving portion in a preferably linear insertion direction, and the first coupling portion and the second coupling portion and thus the end effector and the lifting tube are connectable to one another by way of this insertion, in particular pushing, of the insertion portion into the receiving portion in the insertion direction. In this sense, the insertion portion and the receiving portion are in particular designed such that, by inserting, in particular pushing, the insertion portion into the receiving portion in the insertion direction, a connection between the end effector and the lifting tube can be established, in particular the end effector can be fastened to the lifting tube.

The insertion portion and the receiving portion are additionally designed, in particular coordinated with one another, such that the insertion portion can be inserted, in particular pushed, into the receiving portion along the insertion direction in different, in particular arbitrary, rotary positions about an end effector rotation axis orthogonal to the insertion direction.

Such an embodiment enables a particularly simple coupling of the end effector to the lifting tube, since only the first coupling portion and the second coupling portion have to be moved relative to one another along the insertion direction in order to connect the end effector and the lifting tube. In particular, after the insertion portion has been pushed into the receiving portion, no additional actions are required in order to establish a connection between the end effector and the lifting tube. Due to the fact that the insertion portion can be inserted into the receiving portion in any rotary positions about the end effector rotation axis, in particular a complicated alignment of the end effector relative to the lifting tube is spared, which makes coupling even simpler and more intuitive. In particular, this makes it possible, conversely, for the receiving portion to be pushed onto the insertion portion from different angles about the end effector rotation axis along a feed direction opposite to the insertion direction, and thus the insertion portion is inserted into the receiving portion.

The insertion portion and the receiving portion are preferably designed in such a way that the insertion portion can be inserted, in particular pushed, into the receiving portion along the insertion direction in only one insertion direction, but in different, in particular arbitrary, rotary positions about an end effector rotation axis orthogonal to the insertion direction. In this respect, the insertion portion can be pushed into the receiving portion exclusively along a single direction, the insertion direction, but the insertion portion can be rotated in any desired manner about a rotation axis orthogonal to the insertion axis. Preferably, the insertion direction is oriented orthogonally to the lifting tube longitudinal axis, in particular horizontally. The end effector rotation axis is then preferably oriented parallel to the lifting tube longitudinal axis.

Advantageously, the lifting tube-side, first coupling portion comprises the receiving portion and the end effector-side, second coupling portion comprises the insertion portion. Such a design promotes, for example, an end effector held ready in an end effector magazine from different directions of rotation about the end effector rotation axis with the lifting tube.

Particularly intuitive operation can then arise if the receiving portion has a stop for the insertion portion, wherein the stop limits an insertion path of the insertion portion in the receiving portion in the insertion direction and thus defines an end position of the insertion portion in the receiving portion in the insertion direction.

Advantageously, the receiving portion comprises a guide slot which extends axially along the insertion direction. The guide slot provides in particular a linear guide for the insertion portion along the insertion direction. The guide slot can be formed by a recess in the first or second coupling portion.

Preferably, the guide slot comprises an open end (receiving opening) for introducing the insertion portion and a closed end which limits an insertion path of the insertion portion in the receiving portion in the insertion direction. The closed end in this sense forms a stop for the insertion portion. The stop defines in particular an end position of the insertion portion in the receiving portion in the insertion direction. Such an embodiment makes a coupling process even more intuitive, since the operator merely has to move the first coupling portion and the second coupling portion relative to one another in the insertion direction in order to couple the end effector to the lifting tube until a resistance by the stop is detected.

As mentioned above, the proposed coupling device makes it possible to insert the end effector into the receiving portion in any rotary positions about an end effector rotation axis orthogonal to the insertion direction. Furthermore, it can also be advantageous if the insertion portion and the receiving portion are designed in such a way that the insertion portion and receiving portion—and thus the first and second coupling portions—even when the insertion portion is already inserted in the receiving portion, in particular is located at the stop in the end position, can be rotated relative to one another about the end effector rotation axis.

In this respect, the end effector can also be rotatable relative to the lifting tube in the coupled state. In this way, it is possible, for example, to modify a rotational position of the end effector and thus of an object connected to the end effector in the held state, for example in order to transfer the object into a defined set-down position.

In this context, it can be advantageous if the insertion portion is designed to be rotationally symmetrical about the end effector rotation axis, at least in portions, i.e., at least over an angular range about the end effector rotation axis.

In order to promote rotatability even when the insertion portion is in contact with the stop or the closed end of the guide slot, it can be advantageous if the stop is provided by a wall of the guide slot, wherein the wall is designed to be complementary to a wall delimiting the insertion portion about the rotation axis, in particular has its negative shape.

The insertion portion and the receiving portion are preferably designed, in particular coordinated with one another, in such a way that the insertion portion is held in a form-fitting manner along the end effector rotation axis, i.e., in particular in the vertical direction, when it is received in the receiving portion. An undesired drop of the end effector, for example as a result of gravity, can thus be effectively prevented.

Advantageously, the insertion portion can have a projection which extends in a projection direction from the end effector (when the insertion portion is arranged on the end effector-side coupling portion) or the lifting tube (when the insertion portion is arranged on the lifting tube-side coupling portion). The projection direction and end effector rotation axis preferably run collinearly, i.e., along an identical axis. If the projection is arranged on the end effector, it is particularly advantageous if the projection extends away from one side of the end effector in the projection direction, said side facing away from or being opposite a gripping means of the end effector, for example a suction body.

The receiving portion, in particular guide slot, can then be designed such that, in the inserted state of the insertion portion (i.e., when the insertion portion is pushed into the receiving portion), the receiving portion engages behind or surrounds the projection at least in portions, preferably in such a way that the insertion portion is held in a form-fitting manner in the receiving portion along the end effector rotation axis.

In this context, it can be advantageous if the projection, viewed in the projection direction, widens radially at least in portions, in particular continuously or discontinuously. In this respect, the projection can be designed such that, in at least a first position of the projection, which follows a second position along the projection direction, a radial extent of the projection is greater than in the second position.

Within the scope of an advantageous embodiment, the projection can widen continuously at least in portions in the projection direction. In particular, the projection can widen conically at least in portions in the projection direction, which favors a simple production of the projection.

It is also possible for the projection to have at least one radial overhang or a radially projecting step along its longitudinal extent in the projection direction. For example, the projection can have a base portion extending along the projection direction, in particular along the end effector rotation axis, and an overhang portion adjoining the base portion in the projection direction, the projection in the overhang portion being radially widened at least along an angular region about the end effector rotation axis. In this respect, the projection can have a radial widening along its extent in the projection direction at least in a projection portion which is axially downstream of a base portion of the projection in the projection direction. In such an embodiment, it can then be advantageous if the receiving portion is designed such that it engages behind or surrounds the projection portion in the receiving portion in the inserted state of the insertion portion.

In particular, the projection can have a substantially T-shaped cross section. An embodiment that can be produced particularly easily can then result, for example, if the projection has a first cylinder portion and a second cylinder portion which is axially adjacent to the first cylinder portion in the projection direction, a diameter of the second cylinder portion being greater than a diameter of the first cylinder portion. The receiving portion can then in particular be designed such that it engages behind or surrounds the second cylinder portion in the inserted state of the insertion portion. The cylinder can be designed as a solid cylinder or as a hollow cylinder.

A particularly reliable holding of the end effector on the lifting tube can be provided when the receiving portion and the insertion portion are designed to be complementary or substantially complementary in a cross section along the insertion direction, preferably in such a way that the insertion portion is held in a form-fitting manner in the receiving portion along the end effector rotation axis. In particular, the receiving portion can have a negative shape of the insertion portion when viewed in a cross section along the insertion direction.

In the context of an advantageous development, the coupling device can be designed such that, in at least one inserted position of the insertion portion in the receiving portion, preferably in the end position of the insertion portion (i.e., when the insertion portion is in contact with the stop or at the closed end of the guide slot), a fluid connection between the lifting tube and the end effector is established. In particular when the end effector is designed as a suction gripping device, it is thus possible to supply the suction gripping device with negative pressure via the coupling device. In this context, it is particularly advantageous if the lifting tube has a tube interior and the fluid connection is fluidically connected to the tube interior, in particular in such a way that the end effector can be supplied with negative pressure through the tube interior. In this way, additional fluid lines, in particular external fluid lines, can be omitted, which further simplifies coupling of the end effector and also reduces interfering contours during gripping.

In this context, it can be advantageous if the insertion portion has a first fluid opening, in particular a bore, and wherein the receiving portion has a second fluid opening, in particular a bore, in such a way that, at least in an insertion position of the insertion portion in the receiving portion, preferably in the end position of the insertion portion in the receiving portion, a flow connection is established between the first and the second fluid opening, in particular the first and the second fluid opening are aligned with one another, further in particular coaxially with respect to one another, in particular coaxially with respect to the end effector rotation axis. The first fluid opening is preferably arranged centrally, in particular concentrically with respect to the end effector rotation axis, on the insertion portion. As explained above, the projection can be formed by a hollow cylinder. It is then conceivable, for example, that an axial cylinder opening of the hollow cylinder provides the first fluid opening. Depending on the arrangement, the first or the second fluid opening is either fluidically connected to the end effector, e.g., suction gripping device, or to the lifting tube. It can be particularly advantageous if the insertion portion is arranged on the end effector and the first fluid opening is fluidically connected to the end effector and if the receiving portion is arranged on the lifting tube and the second fluid opening is fluidically connected to the lifting tube, in particular a tube interior of the lifting tube.

Within the scope of an advantageous development, the coupling device can have a rotary locking device. The rotary locking device is in particular designed to secure the end effector in the coupled state (i.e., when the insertion portion is inserted into the receiving portion, in particular the insertion portion is located in the end position) against a rotation about the end effector rotation axis.

The rotary locking device can preferably be designed to fix the end effector in a latching manner in a locking configuration. For example, the rotary locking device can have at least one, in particular translationally or rotationally displaceable, latching element and at least one latching receptacle for receiving the latching element in a latched manner. The latching element and the latching receptacle are preferably designed and arranged in such a way that the latching element engages in the latching receptacle in at least one rotational position of the insertion portion about the end effector rotation axis. In order to enable a rotary locking in different rotational positions of the end effector about the end effector rotation axis, the latching device can have a plurality of latching elements. The latching elements can in particular be arranged distributed along a circumference around the end effector rotation axis.

The at least one latching element can be arranged on the lifting tube side, for example on the receiving portion. The at least one latching receptacle can then be arranged on the end effector side, in particular on the insertion portion. For example, it is conceivable that the at least one latching receptacle is designed as a local recess in the insertion portion. It is also conceivable for the at least one latching element to be arranged on the end effector side and the at least one latching receptacle to be arranged on the lifting tube side.

In the context of an advantageous development, the rotary locking device can be designed in such a way that a rotary locking means can be activated by axial displacement of the insertion portion relative to the receiving portion along the insertion direction (rotational movement of the end effector about the end effector rotation axis blocked) and can be deactivated again (rotational movement of the end effector about the end effector rotation axis released), in particular can be activated by displacement in the insertion direction and can be deactivated again counter to the insertion direction. This favors a simple end effector change, since in particular no additional handles are required in order to release the rotary locking device. It is particularly advantageous if the rotary locking device is designed such that a displacement of the end effector counter to the insertion direction (for example, in order to decouple the end effector) is not blocked.

In an embodiment of the rotary locking device with a latching element and latching receptacle, these can in particular be designed such that the latching element can be inserted into the latching receptacle in at least one rotational position of the end effector about the end effector rotation axis along the insertion direction, and a rotary locking can thus be activated. In this context, it can be particularly advantageous if the latching element is arranged on the closed end of the guide slot (receiving portion) and the at least one latching receptacle is arranged on the insertion portion or vice versa.

The latching element is preferably mounted translationally or rotationally displaceably, in particular pivotably, in particular between a locking position in which the latching element engages in the latching receptacle, and a release position in which the latching element does not engage in the latching receptacle. Furthermore, it can be advantageous if the latching element is acted upon, in particular pre-stressed, preferably spring-loaded, into the locking position. The latching element can then be designed in such a way that the latching element can be transferred into the release position by being acted upon in the insertion direction against the pre-stressing. In embodiments with a translationally displaceable latching element, a displacement axis can thus run parallel to the insertion direction. In embodiments with a pivotably mounted latching element, a pivot axis can run orthogonally in particular to the insertion direction. As explained in greater detail below, such an embodiment promotes simple and intuitive operation of the tube lifter. In this context, it can be particularly advantageous if the latching element is arranged flush with a wall forming the stop of the receiving portion of the guide slot in the release position.

Within the scope of an advantageous development, the coupling device can have an axial locking device which is designed to secure the insertion portion against displacement from the receiving portion, i.e., counter to the insertion direction, when the insertion portion is inserted in the receiving portion. The axial locking device in this sense forms a type of captive securing means for the insertion portion and thus for the end effector. In this respect, locking preferably takes place in the horizontal direction. In particular, the axial locking device can be designed to secure the insertion portion against displacement within the receiving portion counter to the insertion direction.

It is particularly advantageous if the axial locking device is designed such that, when a predetermined insertion position of the insertion portion is reached in the receiving portion, in particular when the end position is reached (i.e., when the insertion portion rests against the stop of the receiving portion or the guide slot), the axial locking device automatically locks. In this respect, after the insertion portion has been pushed into the receiving portion, the insertion portion can be automatically locked, in particular without an operator having to take additional steps. For example, it is conceivable that the axial locking device has one or more latching lugs or swivel bars which are loaded, in particular spring-loaded, into a locking position. The locking device can in particular be designed such that a locking can be manually released, for example by actuating a button.

Within the scope of an advantageous development, the tube lifter can also have an operating device with an operating handle, in particular an operating handle that can be grasped one-handedly, for displacing the lifting tube. The operating device is in particular arranged, in particular held, at one end of the lifting tube. In this respect, the operating device is arranged in particular between the lifting tube and the end effector. In one embodiment with an operating device, the lifting tube-side coupling portion, in particular the receiving portion, can then be arranged on the operating device. For example, it is conceivable that the receiving portion, particular the guide slot, is formed in a housing of the operating device.

The invention is explained in more detail below with reference to the figures. In the drawings:

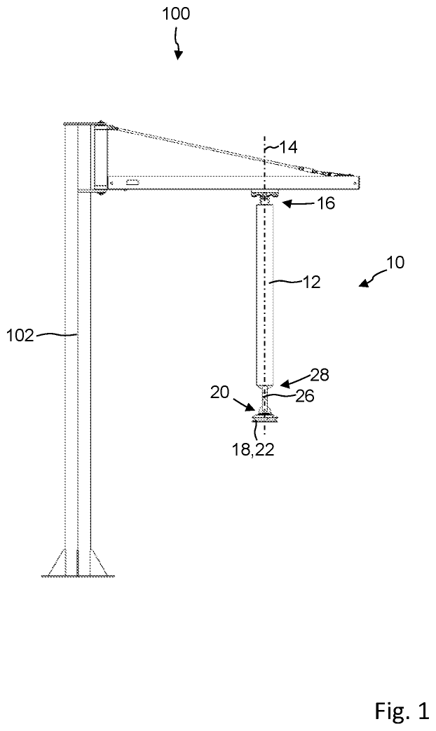

FIG. 1 shows a sketched representation of an embodiment of a tube lifter;

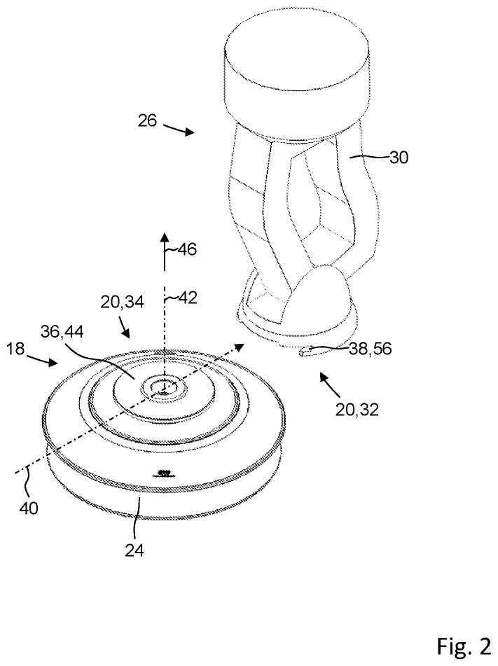

FIG. 2 shows a sketched representation to explain the coupling device in one perspective;

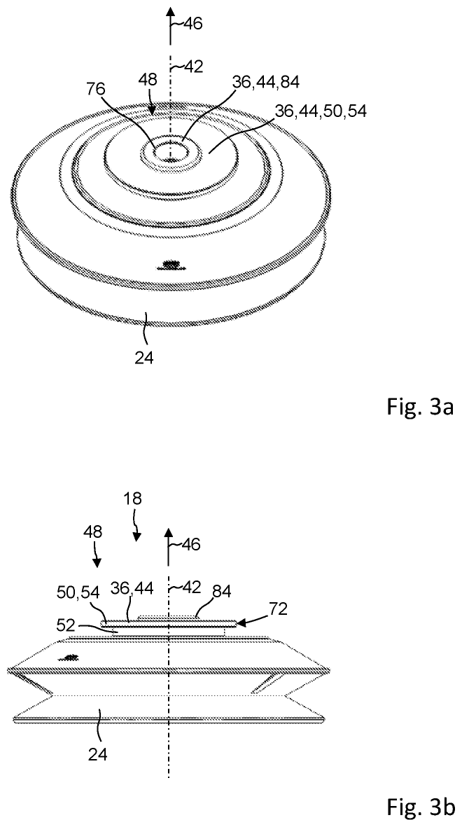

FIG. 3a, b show illustrations of the end effector with end effector-side coupling portion in a perspective view (view a) and in a side view (view b);

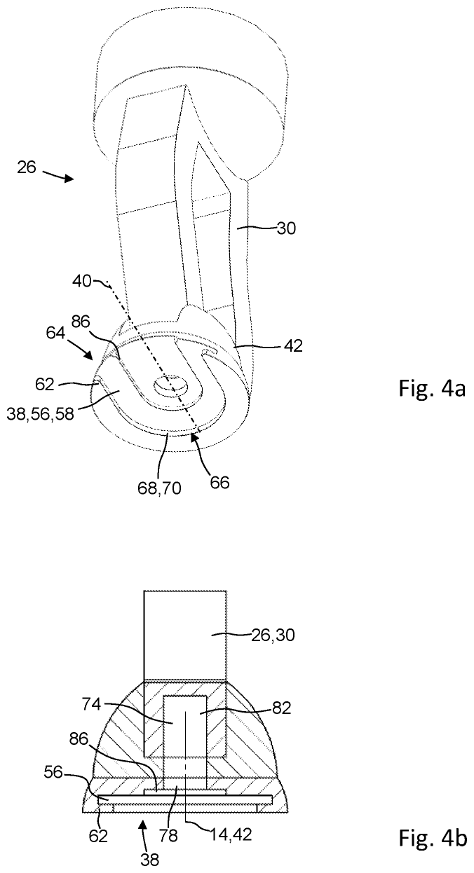

FIG. 4a, b show sketched representations of the operating device with a lifting tube-side coupling portion in a perspective view (view a) and in a sectional view (view b);

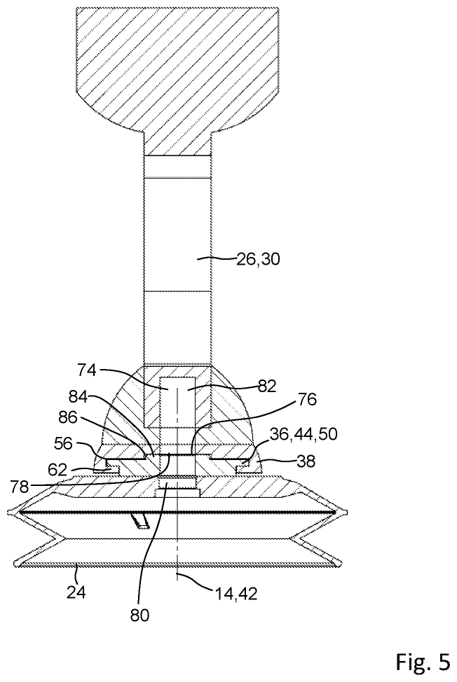

FIG. 5 shows a sketched representation of the coupling device in the connected state of the first and second coupling portion in a sectional view;

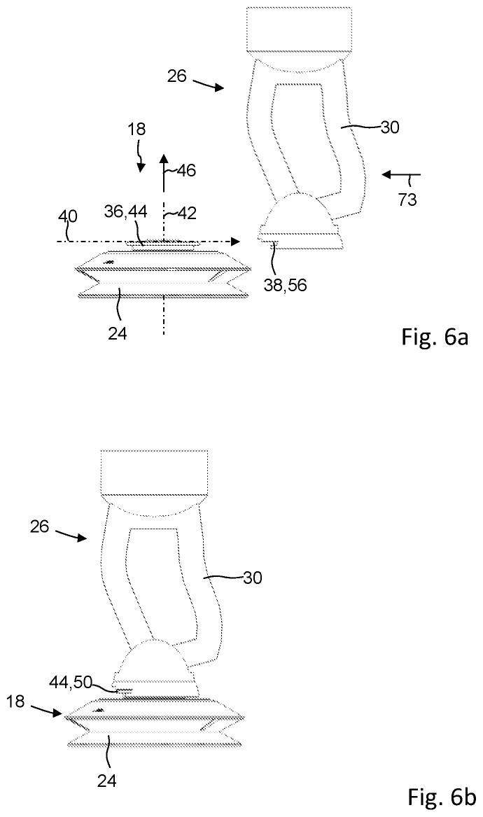

FIG. 6a, b show sketched representations to explain the operating principle of the coupling device;

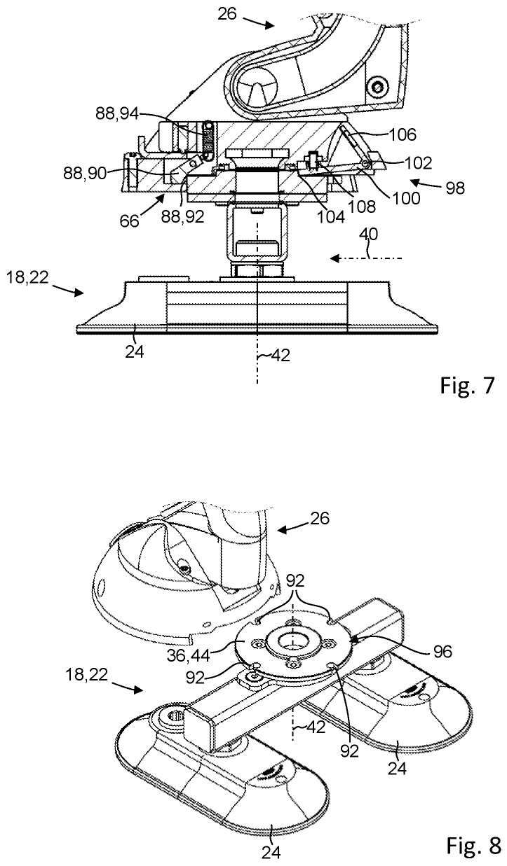

FIG. 7 shows a sketched representation of an assembly of a further embodiment of a tube lifter with a rotary locking device in a sectional view; and

FIG. 8 shows a sketched representation of the tube lifter according to FIG. 7, in a perspective view.

In the following description and in the figures, identical reference signs are in each case used for identical or corresponding features.

FIG. 1 shows an embodiment of a tube lifter, which is denoted as a whole by reference sign 10. In the example shown, the tube lifter 10 is part of a superordinate handling system 100. The handling system 100 comprises a manipulator 102 on which the tube lifter 10 is held. The manipulator 102 is designed as a column-mounted slewing crane, by way of example.

The tube lifter 10 comprises a lifting tube 12 which extends along a lifting tube longitudinal axis 14. As can be seen from FIG. 1, the lifting tube longitudinal axis 14 of the lifting tube 12 corresponds to the vertical. The lifting tube 12 encloses a tube interior, in which a vacuum is produced by means of a vacuum supply (not shown in greater detail) in the operating state. Depending on the pressure level in the tube interior, the lifting tube 12 is reversibly shortened or extended, for example under the action of gravitational force.

In the example, the lifting tube 12 is fastened to the manipulator 102 at a first (upper) end 16 and is thus displaceable by the manipulator 102. In embodiments (not shown), it is also conceivable for the lifting tube 12 to be connected at its upper end 16 to another support or frame.

The tube lifter 10 also comprises an end effector 18 for gripping an object (not shown). The end effector 18 is connected to the lifting tube 12 in a repeatably releasable manner via a coupling device 20 (explained in detail below). By shortening the lifting tube 12, the end effector 18 and an object held by the end effector 18 can thus be lifted.

By way of example and preferably, the end effector 18 is designed as a suction gripping device 22 for suctioning an object. Specifically, the suction gripping device 22 has a suction body 24 for contact with an object to be gripped (cf. FIG. 3b). As explained in detail below, the suction gripping device 22 can preferably be supplied with a vacuum through the tube interior of the lifting tube 12.

In order to displace the lifting tube 12 and the end effector 18, an operating device 26 is provided which is arranged between the lifting tube 12 and the end effector 18 at the second (lower) end 28 of the lifting tube 12. As can be seen from FIG. 2, the operating device 26 comprises a handle 30, which is shaped in particular in such a way that an operator can grip it using one hand.

As mentioned above, the end effector 12 can be connected to the lifting tube 12 in a repeatably releasable manner via a coupling device 20. The coupling device 20 has a lifting tube-side first coupling portion 32 and an end effector-side second coupling portion 34. In the example, the lifting tube-side first coupling portion 32 is arranged on the operating device 26. In this respect, the end effector 18 can be connected to the operating device 26 (and via it to the lifting tube 12) by means of the coupling device 20.

The end effector-side second coupling portion 34 comprises an insertion portion 36 and the lifting tube-side first coupling portion 32 has a corresponding receiving portion 38 for receiving the insertion portion 36. In embodiments (not shown), a reverse arrangement is also possible. In this sense, the end effector-side second coupling portion 34 can comprise the receiving portion 38 and the lifting tube-side first coupling portion 32 can comprise the insertion portion 36.

As explained in detail below, the insertion portion 36 and receiving portion 38 are coordinated with one another in such a way that the insertion portion 36 can be inserted into the receiving portion 38 along only one insertion direction 40, but in any rotary positions about an end effector rotation axis 42 orthogonal to the insertion direction 40.

The insertion direction 40 is formed by way of example and preferably orthogonally to the lifting tube longitudinal axis 14 and in this sense extends horizontally in the example. The end effector rotation axis 42 accordingly runs parallel to the lifting tube longitudinal axis 14 in the example and in this sense vertically (cf. FIG. 2).

The insertion portion 36 has a projection 44 which, in a projection direction 46, in particular collinear with the end effector rotation axis 42, extends away from the end effector 18 (cf. FIGS. 2 and 3a), in the example from an upper side 48 of the end effector 18 facing away from the suction body 24 (suction gripping device 22).

As can be seen from FIG. 3b, the projection has a radial overhang 50. By way of example and preferably, the projection 44 is designed to be rotationally symmetrical about the end effector rotation axis 42.

In the specific example, the projection 44 has a first cylinder portion 52 and a second cylinder portion 54 adjoining the first cylinder portion 52 in the projection direction, a diameter of the second cylinder portion 54 being greater than a diameter of the first cylinder portion 52. The second cylinder portion 54 (overhang portion) forms the radial overhang 50.

As can be seen from FIG. 5, the insertion portion 36 (projection 44), viewed along the insertion direction 42, has a substantially T-shaped cross section.

In embodiments (not shown), it is also conceivable, for example, for the projection 44 to widen conically in the projection direction 46.

The receiving portion 38 is preferably designed to be complementary to the insertion portion 36, so that the insertion portion 36 is held in the receiving portion 38 in a form-fitting manner along the end effector rotation axis 42 or the lifting tube longitudinal axis 14 in the inserted state.

As can be seen, for example, from FIG. 4a, the receiving portion 38 comprises a guide slot 56 which extends along the insertion direction 42. The guide slot 56 forms a linear guide for the insertion portion 36 and in this sense defines the insertion direction 42. In the example, the guide slot 56 is designed as a recess 58 in a housing portion 60 of the operating device 26.

As shown in FIG. 4b, the guide slot 56, viewed along the insertion direction 42, has a cross section which is substantially complementary to the insertion portion (in the example substantially C-shaped), so that the receiving portion 38, in the inserted state of the insertion portion 36, surrounds the radial overhang 50 (second cylinder portion 54) of the insertion portion 36 with a wall 62. In this sense, a form-fitting connection effective along the end effector rotation axis 42 or the lifting tube longitudinal axis 14 is formed (cf. FIG. 5).

Due to the fact that the insertion portion 36 (projection 44) is designed to be rotationally symmetrical about the end effector rotation axis 42, the insertion portion 36 and thus the end effector 18 can also be rotated about the end effector rotation axis 42 in the connected state, i.e., when the insertion portion 36 is inserted into the receiving portion 38.

As shown in FIG. 4a, the guide slot 56 (receiving portion 38) has an open end 64 for inserting the insertion portion 36 and a closed end 66. The closed end 66 forms a stop 68 for the insertion portion 36 and in this respect defines an end position of the insertion portion 36 in the receiving portion 38.

In the example, the stop 68 is formed by a wall 70 of the guide slot 56. By way of example and preferably, the wall 70 is designed to be complementary to a wall 72 (cf. FIG. 3b) delimiting the projection 44 (insertion portion 36) about the end effector rotation axis 42. The wall 70 of the guide slot 56 is also designed to be rotationally symmetrical about the end effector rotation axis 40 (cf. FIGS. 4a and 4b).

As can be seen from FIG. 4a, the guide slot 56 (receiving portion 38) is in particular aligned relative to the operating device 26 in such a way that the open end 64 of the guide slot 56 faces away from an operator grasping the handle 30, i.e., is located at the front of the operating device 26 (proximally). In embodiments (not shown), the guide slot 56 can also be rotated by 180° about the end effector rotation axis 42. In this sense, the guide slot 56 (receiving portion 38) can be facing an operator grasping the handle 30 (distal).

As illustrated in FIGS. 6a and 6b, an operator for coupling the end effector 18 to the lifting tube 12 only has to push the insertion portion 36 along the insertion direction 40 into the receiving portion 38, for example by moving the operating device 26 (and thus the receiving portion 38) relative to the end effector 18 in a feed direction 73 opposite to the insertion direction 40 (to the left in FIG. 6a). Due to the fact that the insertion portion 36 is designed to be rotationally symmetrical about the end effector rotation axis 42, the receiving portion 38 can be pushed on from different angles about the end effector rotation axis 42 in the feed direction 73 over the insertion portion 36.

In the embodiment shown, the coupling device 20 is also designed such that, in the end position of the insertion portion 36 in the receiving portion 38, a fluidic connection 74 is produced between the lifting tube 12, in particular the tube interior of the lifting tube 12, and the end effector 18, in particular the suction body 24 (cf. FIG. 5). As mentioned above, the fluid connection 74 makes it possible to supply the end effector 18, in particular the suction body 24, with a vacuum through the tube interior of the lifting tube 12.

As can be seen from FIG. 5, the insertion portion 36 has a first fluid opening 76 and the receiving portion 38 has a second fluid opening 78 in such a way that, when the insertion portion 36 is in the end position, i.e., rests against the stop 68 (wall 70), a fluidic connection is established between the first fluid opening 76 and the second fluid opening 78.

The first fluid opening 76 is in this case fluidically connected to the suction body 24 via a first fluid channel 80. Preferably, the first fluid opening 76 is arranged concentrically about the end effector rotation axis 42. In the specific example, the first fluid opening 76 and the first fluid channel 80 are formed in the projection 44 by a recess, in particular a bore. The first and second cylinder portion 52 and 54 are hollow-cylinder portions in this sense.

The second fluid opening 78 on the receiving portion 38 is fluidically connected to the tube interior of the lifting tube 12 via a second fluid channel 82. By way of example and preferably, the second fluid channel 82 can run through the handle 30 of the operating device 26. The handle 30 can, in this sense, be designed as a hollow body.

In order to seal the first and the second fluid opening 76, 78, the projection 44 can have a sealing portion 84. As shown in FIGS. 3 and 5, the sealing portion 84 can, when viewed in particular in the projection direction 46, adjoin the radial overhang 50 (overhang portion or second cylinder portion 54).

By way of example and preferably, the sealing portion 84 is likewise designed to be rotationally symmetrical about the end effector rotation axis 42. The receiving portion 38 (guide slot 56) can then have a complementary recess 86 (cf. FIGS. 4a and 5).

In embodiments (not shown), it is also possible for no fluidic connection 74 to be provided, for example when the end effector 18 is designed as a mechanical gripper. The fluidic connection 74 is optional in this sense.

FIGS. 7 and 8 show a further embodiment of a tube lifter 10, in which the coupling device 20 has a rotary locking device 88. The rotary locking device 88 is designed to secure the end effector 18 against rotation about the end effector rotation axis 42 in the coupled state.

In the example shown, the rotary locking device 88 is designed as a latching device comprising a latching element 90 and at least one, in the example four, latching receptacles 92 for receiving the latching element 90 in a latching manner. The latching element 90 is arranged, for example, on the lifting tube side, and the latching receptacles 92 are arranged on the end effector side. In embodiments (not shown), however, a reverse arrangement is also possible.

In the specific example, the latching receptacles 92 are arranged on the insertion portion 36. By way of example and preferably, the latching receptacles 92 are arranged so as to be distributed along a circumference around the end effector rotation axis 42.

The latching element 90 and the latching receptacles 92 are designed such that, when the latching element 90 is received in one of the latching receptacles 92, a rotational movement of the end effector 18 about the end effector rotation axis 42 is blocked.

As can be seen from FIG. 7, the latching element 90 is arranged by way of example and preferably in the region of the closed end 66 of the guide slot 56 (receiving portion 38). As mentioned above, the latching element 90 is arranged such that the latching element 90 can be inserted into the latching receptacle 92 by an axial displacement of the end effector 18 in the insertion direction 40, and a rotary locking can thus be activated.

By way of example and preferably, the latching element 90 is held pivotably about a pivot axis so that the latching element 90 can be transferred or pivoted from the locking position shown in FIG. 7 (in which the latching element 90 engages in one of the latching receptacles 92 and thus blocks a rotation of the end effector 18 about the end effector rotation axis 42) into a release position in which the latching element 92 no longer engages in the latching receptacle 92 (and thus a rotation of the end effector 18 about the end effector rotation axis 42 is possible). In embodiments (not shown), the latching element 90 can also be mounted translationally.

By way of example and preferably, the latching element 92 is acted upon in the locking position. In the example, a spring device 94 is provided for this purpose. In this sense, the latching element 92 is pivotable in the direction of the release position against the loading by the spring device 94. As mentioned above, in the release position, the latching element 90 is preferably arranged flush with the wall 66 which forms the stop 70 for the insertion portion 36 (cf. FIG. 4a).

If, for example, the insertion portion 36 is now inserted into the receiving portion 38 in such a rotational position about the end effector rotation axis 42 that a portion 96 arranged between two latching receptacles 92 faces the latching element 90 (i.e., the latching element 90 does not align with no latching receptacle 92; for example if the end effector in FIG. 8 would be rotated by 45° about the end effector rotation axis 42), the latching element 90 is pivoted against the spring pre-stress about the pivot axis until the insertion portion 36 rests against the wall 66 (end position).

In order to activate the rotary locking device 88, the end effector 18 (and thus the insertion portion 36) can then be rotated about the end effector rotation axis 42 until one of the latching receptacles 92 is aligned with the latching element 90 and the latching element 90 snaps into this latching receptacle 92 due to the spring pre-stress.

As can be seen from FIG. 7, the coupling device 20 also comprises an optional axial locking device 98 which is designed to prevent a displacement of the insertion portion 36 from the receiving portion 38, in particular a displacement of the insertion portion 36 from the end position counter to the insertion direction 40. In the example, the axial locking device 98 comprises a swivel bar 100 which is held on the operating device 26 pivotably about a pivot axis 102. In FIG. 7, the swivel bar 100 is shown in a locking position in which the swivel bar 100 interacts with a locking portion 104 of the insertion portion 36, in particular in a form-fitting manner, in such a way that a displacement of the insertion portion 36 against the insertion direction 40 is blocked. In order to release the axial locking device 98, the pivot bar 100 can then be pivoted about the pivot axis 102 in such a way (for example by actuating the actuation portion 106; in FIG. 7 in the clockwise direction) that the locking portion 104 can slide past the swivel bar 100.

By way of example and preferably, the swivel bar 100 is loaded into the locking position, for example by means of a spring device 108. The axial locking device 98 is designed in this respect in such a way that, when the insertion portion 36 is in the end position, it automatically triggers.

Such an axial locking device 98 can also be provided in the embodiment according to FIGS. 1 to 6.

1. A tube lifter, comprising
a lifting tube extending along a lifting tube longitudinal axis;
an end effector;
a coupling device, by means of which the end effector can be coupled to the lifting tube, the coupling device having a lifting tube-side first coupling portion and an end effector-side second coupling portion, one of the coupling portions having an insertion portion (36) and the other coupling portion (32) having a receiving portion for receiving the insertion portion, wherein
the insertion portion and the receiving portion are designed in such a way that the insertion portion can be inserted into the receiving portion in, only, an insertion direction orthogonal to the lifting tube longitudinal axis, and the end effector and the lifting tube can be connected to one another by inserting the insertion portion into the receiving portion in the insertion direction, the insertion portion being insertable into the receiving portion in the insertion direction in different rotary positions about an end effector axis orthogonal to the insertion direction.

2. The tube lifter according to claim 1, wherein the receiving portion has a guide slot which extends axially along the insertion direction.

3. The tube lifter according to claim 2, the guide slot comprising an open end for introducing the insertion portion and a closed end, wherein the closed end forms a stop for the insertion portion, wherein the stop defines an end position of the insertion portion in the receiving portion in the insertion direction.

4. The tube lifter according to claim 3, wherein the insertion portion and the receiving portion are designed such that the insertion portion can also be rotated relative to the receiving portion about the end effector axis when the insertion portion is inserted into the receiving portion.

5. The tube lifter according to claim 3, wherein the insertion portion is designed to be rotationally symmetrical at least in portions about the end effector rotation axis.

6. The tube lifter according to claim 4, wherein the insertion portion and the receiving portion are designed such that the insertion portion is held in the receiving portion in a form-fitting manner along the end effector rotation axis.

7. The tube lifter according to claim 4, wherein the insertion portion has a projection, which extends in a projection direction, collinear with the end effector rotation axis, away from the end effector or the lifting tube.

8. The tube lifter according to claim 7, wherein, in the inserted state of the insertion portion, the receiving portion engages behind or surrounds the projection at least in portions, in such a way that the insertion portion is held in the receiving portion in a form-fitting manner along the end effector rotation axis.

9. The tube lifter according to claim 7, wherein the projection has a radial overhang.

10. The tube lifter according to claim 7, wherein the projection has a substantially T-shaped cross section.

11. The tube lifter according to claim 4, wherein the receiving portion is designed to be complementary to the insertion portion in a cross section viewed along the insertion direction, has a negative shape of the insertion portion.

12. The tube lifter according to claim 4, wherein the coupling device is designed such that in at least one insertion position of the insertion portion in the receiving portion, in the end position of the insertion portion in the receiving portion, a fluid connection between the lifting tube and the end effector is established.

13. The tube lifter according to claim 12, wherein the insertion portion has a first fluid opening, arranged concentrically about the end effector rotation axis, and wherein the receiving portion has a second fluid opening, in such a way that, at least in the insertion position of the insertion portion in the receiving portion, in the end position of the insertion portion in the receiving portion, a fluidic connection is established between the first fluid opening and the second fluid opening, the first and the second fluid opening are aligned with one another, further are arranged coaxially to one another.

14. The tube lifter according to claim 1, wherein the coupling device has a rotary locking device which is designed to secure the end effector against rotation about the end effector rotation axis when the insertion portion is inserted into the receiving portion, is inserted in the end position.

15. The tube lifter according to the claim 14, wherein the rotary locking device is designed such that a rotary locking can be activated and deactivated again by axial displacement of the insertion portion relative to the receiving portion along the insertion direction, without blocking a displacement of the end effector against the insertion direction.

16. The tube lifter according to claim 15, the rotary locking device comprising a latching element and at least one latching receptacle for receiving the latching element, wherein the latching element and the latching receptacle are designed and arranged such that the latching element can be inserted into the latching receptacle along the insertion direction in at least one rotary position of the end effector about the end effector rotation axis, and thus a rotary locking can be activated.

17. The tube lifter according to claim 16, wherein the latching element is held displaceably between a locking position and a release position, translationally or rotationally, wherein the latching element is pre-stressed into the locking position, spring-loaded, wherein the latching element can be transferred against the pre-stress into the release position by being acted upon in the insertion direction.

18. The tube lifter according to claim 1, wherein the coupling device has an axial locking device, which is designed to secure the insertion portion against displacement from the receiving portion, against displacement within the receiving portion counter to the insertion direction, wherein the axial locking device is designed such that the axial locking device automatically locks when a predetermined insertion position of the insertion portion in the receiving portion is reached, when the end position is reached.

19. The tube lifter according to claim 1, further comprising an operating device having an operating handle for moving the lifting tube, wherein the lifting tube-side coupling portion is arranged on the operating device.
